(19) United States
(12) Patent Application Publication
(10) Pub. No.: US 2009/0065644 A1
(43) Pub. Date: Mar. 12, 2009

(54) Device and method for non-symmetrical mixed carbon-metal assembly

(75) Inventor: Emmanuel Jacques, Fonsorbes (FR)

Correspondence Address: PERMAN & GREEN, 425 POST ROAD, FAIRFIELD, CT, 06824, US

(73) Assignee: Airbus France, Toulouse Cedex 9 (FR)

(21) Appl. No.: 11/909,334

(22) PCT Filed: Mar. 8, 2006
(86) PCT No.: PCT/FR2006/050202

§ 371 Date: Jul. 21, 2008

(30) Foreign Application Priority Data
Mar. 23, 2005 (FR) 05 50759

(51) Int. Cl. B64C 1/26; B29C 65/00

(52) U.S. Cl. 244/123.1; 403/404

(57) ABSTRACT

The invention concerns an assembling device including a splice bar (1) and a backing plate (2) for securing at least first (3) and second (4) structural elements received between the splice bar (1) and the backing plate (2). The invention is characterized in that the backing plate (2) includes a number of fixing points (M, N) less than the number of fixing points (P, Q) of the splice bar so that the first (3) and second (4) structural elements are fixed between the splice bar (1) and the backing plate (2) by a number of fixing points (M+N) less than the number of fixing points (P+Q) of the structural elements on the slice bar (1), the assembly being thus a non-symmetrical assembly, at least one of the structural elements being an element made of composite materials.

### CROSS-REFERENCE TO RELATED APPLICATIONS

This application is the National Stage of International Application No. PCT/FR2006/050202, International Filing Date, Mar. 8, 2006, which designated the United States of America, and which international application was published under PCT Article 21(2) as WO Publication No. WO 2006/100400 and which claims priority from French Application No. 0550759, filed Mar. 23, 2005.

### BACKGROUND

1. Field

The disclosed embodiments concern a device and a process for dissymmetric splicing, which are particularly applicable to producing highly-loaded structures, especially in aeronautics.

2. Brief Description

During the manufacture of an aircraft, various sections are made of assemblies of stiffened or unstiffened panels, ribs and frames.

An important element of an aircraft is the central section receiving the wings of the airplane. This box-shaped body element undergoes very significant stresses, and it is desirable to assure a good transfer of stress from the wings to this box body and from this box body to the rest of the structure.

More and more, aircraft manufacture calls upon composite materials, and in particular, structures based on carbon and mixed metal-composite structures are used.

The joining of the parts constituting the various sections of the box body and their joining to each other notably employs splicing techniques, i.e., joining the panels or frames to each other by means of connectors bolted or riveted onto these panels and retransmitting stress between the panels or frames.

### SUMMARY

The disclosed embodiments relate to an improvement of joining by splicing, particularly suited for joining elements of different nature, such as composite panels and metal splice plates.

It is particularly applied to assembling a central box body of an aircraft of large dimensions made of composite materials that must be pre-assembled and then moved to receive the wings of the aircraft, while preserving its dimensional characteristics during the assembly phase.

To do this, the disclosed embodiments principally relate to a splicing device having a splice plate and a splice counterplate for joining at least one first and one second structural element that are taken up between the splice plate and the splice counterplate, characterized in that the splice counterplate bears a number of attachment points that are fewer than the number of attachment points of the splice plate, so that said first and said second structural elements are attached between the splice plate and the splice counterplate by a number of attachment points that are fewer than the number of attachment points of said structural elements onto the splice plate, splicing being thus dissymmetric, and at least one of the structural elements is an element made of composite material.

The disclosed embodiments also relate to a process for assembly by splicing a box body and a wing element of the aircraft, characterized in that a box body is constructed from structural panels of composite material assembled by splice plates, at least one splice plate bearing a first arm initially fastened by a distal attachment point onto at least one panel, the other attachment points for said arm onto said panel remaining free, the box body is presented facing the wing element with which the box body is assembled, the wing element is joined to a second arm of the splice plate by a distal attachment point of said second arm, and said panel and said wing element are clamped between the splice plate and a splice counterplate by means of attachment points positioned between said distal attachment point of the first arm and the distal attachment point of the second arm.

The device according to the disclosed embodiments particularly permits simplifying the assembly of an aircraft box body to the wings of this aircraft and a better transfer of stress from the wing onto the box body.

### BRIEF DESCRIPTION OF THE DRAWINGS

Other characteristics and advantages of the disclosed embodiments will appear upon reading the description that follows of one non-limiting example of the disclosed embodiments in reference to the figures, which show:

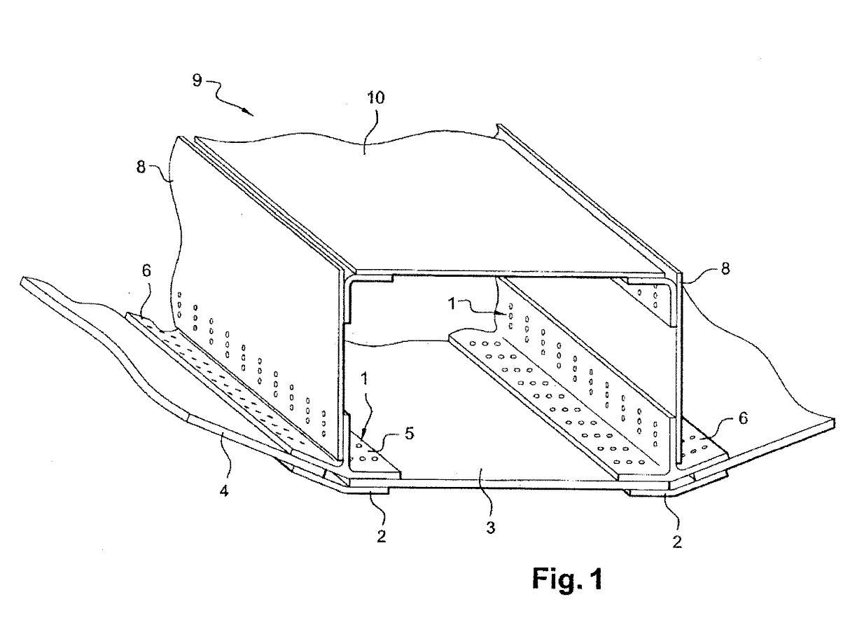

in FIG. 1: a schematic perspective view of one example of embodiment of an assembly of a box body and a wing element according to the disclosed embodiments.

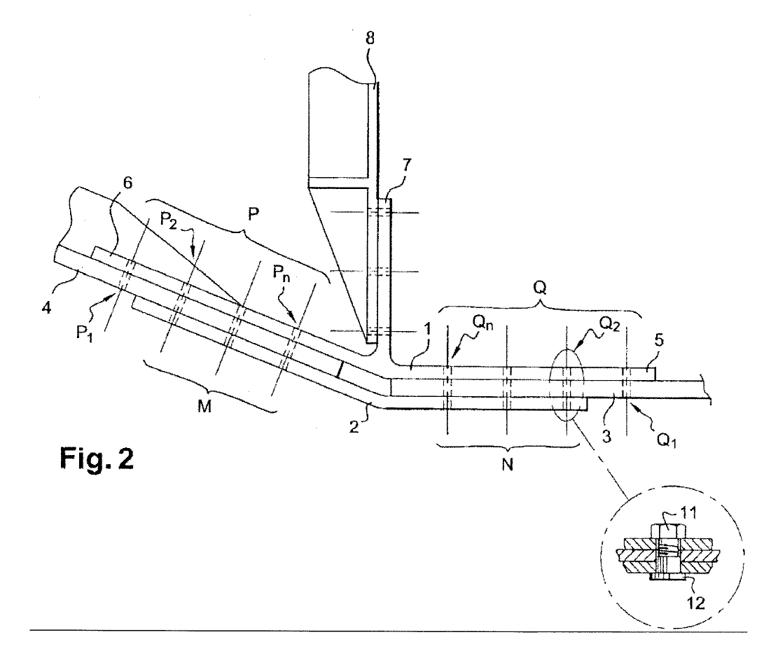

in FIG. 2: a side view of a splicing device according to the disclosed embodiments.

### DETAILED DESCRIPTION

The splicing device shown in FIG. 1 comprises a splice plate 1 and a splice counterplate 2 for joining at least one first structural element 3 and one second structural element 4 taken up between splice plate 1 and splice counterplate 2.

The first structural element 3, according to the example, is a lower part of a central box body of an aircraft that takes up the lower wing elements of the aircraft wing, and the second structural element 4 is one of the wing elements.

The central box body, in particular, is a box body made of carbon-based composite panels.

The splice plate is positioned on top of said structural element and a splice counterplate comes to hold these structural elements together from the bottom.

According to the disclosed embodiments, splice counterplate 2 bears a number of attachment points M, N that are fewer than the number of attachment points P, Q of the splice plate so that said first 3 and second 4 structural elements are attached between splice plate 1 and splice counterplate 2 by a number of attachment points M+N that are fewer than the number of attachment points P+Q of said structural elements onto splice plate 1; thus splicing is dissymmetric.

A first advantage of such a dissymmetric splicing is that it permits a better distribution of stress at the level of the attachment, and a second advantage is that it permits pre-mounting the elements of the panel assembly, handling of the box body and even transport of the box body to a distant site for assembly of the wing elements, pre-positioning and pre-attaching the wing element onto splice plate 1, then a final positioning of the splice counterplate without requiring a disassembly of the elements already assembled onto the splice plate, which might cause a misalignment of the attachment points of both the walls of the box body as well as the wing element with the box body.

A third advantage of the disclosed embodiments combining dissymmetric splicing and composite structural elements is the mass gain obtained, which provides a static strength and a fatigue strength equivalent to those of a symmetric splicing on metal structural elements.

Due to the fact that the splice counterplate bears a smaller number of points for attaching onto the structural element, dissymmetric splicing also permits reducing the thermal stress resulting from the differential expansion between metal and composite material, between the metal splice plate and a composite structural element.

According to the example of FIG. 1, and in the case of application of the device of the disclosed embodiments to a central box body receiving elements of the wing, splice plate 1 is a T-shaped splice plate bearing a first arm 5 for attaching a first structural element 3, i.e., the bottom of the box body, a second arm 6 for attaching a second structural element 4, i.e., the wing element, the second arm being roughly an extension of first arm 5, and a third arm 7 for attaching a third structural element 8, i.e., a wall of the box body, for example, the third arm being inclined relative to said first and second arms 5, 6.

Within the scope of the example of FIG. 1, the first and the third structural elements 3, 8 make up the contiguous faces of box body 9, and first arm 5 of the splice plate taking up the first structural element 3 is received on an inner surface of box body 9, second arm 6 leaving the inner space of the box body by its lower lateral edge.

The T-shaped splice plate thus provides the lower border of the box body.

In reference to FIG. 2 specifying a construction detail, splice counterplate 2 and splice plate 1 imprison first and second structural elements 3 and 4.

The points for attaching the structural elements to the splice plate and to the splice counterplate are made up of holes created in the structural elements, the splice plate and splice counterplate, these holes being arranged so that their position coincides in order to take up fastening means 11, 12, such as screw and nut devices or rivets, and to carry out the assembly.

As seen above, the device permits pre-assembly of the elements onto the splice plate by using points for attaching the ends of the splice plate, then a final assembly by means of the splice counterplate, without needing to take apart the preliminary assembly.

Thus, according to the disclosed embodiments, in order to assemble a box body 9 with at least one element 4 of an aircraft wing by splicing, first a box body 9 is constructed from structural panels 3, 8, 10 that are assembled by splice plates, to at least one splice plate 1 bearing a first arm 5 first attached by a distal attachment point Q1 onto at least one panel of the box body, in this case a lower panel of the box body, the other attachment points Q2, . . . , Qn of first arm 5 onto said panel remaining free, and the box body thus formed can be moved; then box body 9 is presented facing wing element 4 with which box body 9 is to be assembled, wing element 4 is aligned and joined to a second arm 6 of the splice plate by a distal attachment point P1 of second arm 6, the box body-wing element assembly being thus precisely positioned, and panel 3 and wing element 4 are clamped between splice plate 1 and a splice counterplate 2 by means of attachment points positioned between said distal attachment point of the first arm and the distal attachment point of the second arm, and the distal attachment points are not taken apart, so as to maintain the correct alignment of the panel elements already positioned.

The disclosed embodiments permits constructing the box body by assembling the panels of the box body onto outer surfaces of the splice plate, then maneuvering this box body, which thus maintains its integrity, so that it can take up the wing elements.

Of course, the left and right wing elements of the aircraft are assembled according to the principle of the disclosed embodiments.

Moreover, the disclosed embodiments are not limited to the example shown, and in particular, the dissymmetric splicing device can be used to join the upper elements of the wing to said box body or can be used to join the other elements of an aircraft or of any other mechanical construction.

1. A splicing device comprising a splice plate and a splice counterplate for joining at least one first and one second structural element taken up between the splice plate and the splice counterplate, wherein the splice counterplate bears a number of attachment points that are fewer than the number of attachment points of the splice plate, so that said first and second structural elements are attached between the splice plate and the splice counterplate by a number of attachment points that are fewer than the number of attachment points of said structural elements onto the splice plate, splicing thus being a dissymmetric splicing, and wherein at least one structural element being made of composite material.

2. The splicing device according to claim 1, further characterized in that the splice plate is a T-shaped splice plate bearing a first arm for attaching a first structural element, a second arm for attaching a second structural element, as an extension of said first arm, and a third arm, for attaching a third structural element, the third arm being inclined relative to said first and second arms.

3. The splicing device according to claim 2 wherein the first and third structural elements are part of contiguous surfaces of a box body, said first arm of the splice plate receiving said first structural element and being taken up on an inner surface of said box body.

4. The splicing device according to claim 2, wherein the splice counterplate and the splice plate imprison the first and the second structural elements.

5. A process for assembly by splicing of a box body and at least one aircraft wing element, wherein the box body is constructed from structural panels of composite material assembled by splice plates, at least one splice plate bearing a first arm attached first by a distal attachment point onto at least one panel, the other attachment points of the first arm on said panel remaining free, the box body is presented facing wing element with which said box body is assembled, said wing element is joined to a second arm of the splice plate by a distal attachment point of the second arm, and said panel and wing element are clamped between said splice plate and a splice counterplate by attachment points positioned between said distal attachment point of the first arm and the distal attachment point of the second arm.

6. The process according to claim 5, wherein the box body is constructed by assembly of box body panels on the outer surfaces of the splice plate.

7. The splicing device according to claim 4 wherein the first and third structural elements are part of contiguous surfaces of a box body and wherein the first arm of the splice plate receiving said first structural element and being taken up on an inner surface of the box body.

8. A spliced structure comprising: a T-shaped splice plate and a splice counterplate for joining at least one first and one second structural element taken up between the splice plate and the splice counterplate, wherein the splice counterplate bears a number of attachment points that are fewer than the number of attachment points of the splice plate, so that said first and second structural elements are attached between the splice plate and the splice counterplate by a number of attachment points that are fewer than the number of attachment points of said structural elements onto the splice plate, splicing thus being a dissymmetric splicing, and wherein at least one structural element being made of composite material; wherein the T-shaped splice plate further comprises a first arm for attaching a first structural element, a second arm for attaching a second structural element as an extension of the first arm, and a third arm for attaching a third structural element, the third arm being inclined relative to the first and second arms, wherein the first and third structural elements are part of contiguous surfaces of a box body, the first arm of the splice plate receiving the first structural element and being taken up on an inner surface of said box body.

9. The spliced structure according to claim 8 further comprising the splice counterplate and the splice plate imprisoning the first and second structural elements.
